(19) United States
(12) Patent Application Publication
(10) Pub. No.: US 2024/0339311 A1
(43) Pub. Date: Oct. 10, 2024

(54) STANDARD ADDITION WORKFLOW FOR QUANTITATIVE ANALYSIS

(71) Applicant: DH Technologies Development Pte. Ltd., Singapore (SG)

(72) Inventors: Thomas R. COVEY, Newmarket (CA); David Michael COX, Toronto (CA); Michael JARVIS, Alliston (CA); Chang LIU, Richmond Hill (CA)

(73) Assignee: DH Technologies Development Pte. Ltd., Singapore (SG)

(21) Appl. No.: 18/294,386

(22) PCT Filed: Aug. 5, 2022
(86) PCT No.: PCT/IB2022/057341

§ 371 Date: Feb. 1, 2024

Related U.S. Application Data
(60) Provisional application No. 63/229,755, filed on Aug. 5, 2021.

(51) Int. Cl. H01J 49/00; H01J 49/16

(52) U.S. Cl. CPC H01J 49/0031; H01J 49/165

(57) ABSTRACT

A method for measuring a concentration of an analyte in a sample includes: sampling, from a first sample, a first one or more droplets for mass analysis, wherein the first sample includes the sample; performing mass analysis on the first one or more droplets to determine a first intensity of an analyte in the first one or more droplets; sampling, from a second sample, a second one or more droplets for mass analysis, wherein the sec-ond sample includes the sample and a first spike of the analyte; performing mass analysis on the second one or more droplets to determine a second intensity of the analyte in the second one or more droplets; fitting a curve to the first intensity and the second intensity; and based on the fitted curve, calculating an analyte concentration for the sample.

### CROSS-REFERENCE TO RELATED APPLICATION

This application is being filed on Aug. 5, 2022, as a PCT International Patent Application that claims priority to and the benefit of U.S. Provisional Application No. 63/229,755, filed on Aug. 5, 2021, which application is hereby incorporated by reference in its entirety.

### BACKGROUND

High-throughput sample analysis is beneficial for analyzing multiple samples more quickly. Mass spectrometry (MS) based methods can achieve label-free, universal mass detection of a wide range of analytes with exceptional sensitivity, selectivity, and specificity. A number of sample introduction systems for MS-based analysis have been improved to provide higher throughput. For instance, acoustic droplet ejection (ADE) has been combined with an open port interface (OPI) to provide a sample introduction system for high-throughput mass spectrometry. When an ADE device and OPI are coupled to a mass spectrometer, the system can be referred to as an acoustic ejection mass spectrometry (AEMS) system. The analytical performance (sensitivity, reproducibility, throughput, etc.) of an AEMS system depends on the performance of the ADE device and the OPI along with the ability to accurately analyze and interpret the results of from the MS system.

### SUMMARY

In accordance with one aspect of the disclosure, a method for measuring a concentration of an analyte in a sample is provided. The sampling may take place from sample wells of a well plate, or sampling locations on a substrate by surface sampling.

In an embodiment, a method is provided for measuring a concentration of an analyte in a sample. The method may include: sampling a first one or more droplets for mass analysis, wherein the first one or more droplets include the sample; performing mass analysis on the first one or more droplets to determine a first intensity of an analyte in the first one or more droplets; sampling a second one or more droplets for mass analysis, wherein the second one or more droplets include the sample and a first spike of the analyte; performing mass analysis on the second one or more droplets to determine a second intensity of the analyte in the second one or more droplets; fitting a curve to the first intensity and the second intensity; and based on the fitted curve, calculating an analyte concentration for the sample.

In an aspect, the method may further include: sampling a third one or more droplets for mass analysis, wherein the third one or more droplets include the sample and a second spike of the analyte, wherein the second spike has a higher concentration of analyte than a concentration of the first spike; performing mass analysis on the third one or more droplets to determine a third intensity of the analyte in the third one or more droplets; and wherein the curve is further fitted to the third intensity.

In an embodiment, a method is provided for measuring a concentration of an analyte in a sample. The method may include: dividing a sample into three equal parts to produce a first sample, a second sample, and a third sample; adding a first spike of the analyte to the second sample, wherein the first spike has a first analyte concentration; adding a second spike of the analyte to the third sample, wherein the second spike has a second analyte concentration that is greater than the first analyte concentration; sampling a first one or more droplets from the first sample; performing a mass analysis on the first one or more droplets to determine a first analyte intensity of the first one or more droplets; sampling a second one or more droplets from the second sample; performing a mass analysis on the second one or more droplets to determine a second analyte intensity of the second one or more droplets; sampling a third one or more droplets from the third sample; performing a mass analysis on the third one or more droplets to determine a third analyte intensity of the third one or more droplets; plotting the first analyte intensity, the second analyte intensity, and the third analyte intensity on a plot having an x-axis of based on concentration of the analyte and a y-axis based on measured intensity; performing a regression to fit a curve to the plotted first analyte intensity, the second analyte intensity, and the third analyte intensity; and calculating an analyte concentration for the sample by determining an x-axis intercept of the fitted curve.

In an embodiment where the sampling is from sample wells of a well plate, the method comprises the following steps: sampling, from a first well of a well plate, a first one or more droplets for mass analysis, wherein the first well includes the sample; performing mass analysis on the first one or more droplets to determine a first intensity of an analyte in the first one or more droplets; sampling, from a second well of the well plate, a second one or more droplets for mass analysis, wherein the second well includes the sample and a first spike of the analyte; performing mass analysis on the second one or more droplets to determine a second intensity of the analyte in the second one or more droplets; fitting a curve to the first intensity and the second intensity; and based on the fitted curve, calculating an analyte concentration for the sample.

In accordance with another aspect of the disclosure, a method for measuring a concentration of an analyte in a sample is provided. The method comprises the following steps: dividing a sample into equal parts across a first well, a second well, and a third well of a well plate; adding a first spike of the analyte to the second well, wherein the first spike has a first analyte concentration; adding a second spike of the analyte to the third well, wherein the second spike has a second analyte concentration that is greater than the first analyte concentration; sampling a first one or more droplets from the first well; performing a mass analysis on the first one or more droplets to determine a first analyte intensity of the first one or more droplets; sampling a second one or more droplets from the second well; performing a mass analysis on the second one or more droplets to determine a second analyte intensity of the second one or more droplets; sampling a third one or more droplets from the third well; performing a mass analysis on the third one or more droplets to determine a third analyte intensity of the third one or more droplets; plotting the first analyte intensity, the second analyte intensity, and the third analyte intensity on a plot having an x-axis of based on concentration of the analyte and a y-axis based on measured intensity; performing a regression to fit a curve to the plotted first analyte intensity, the second analyte intensity, and the third analyte intensity; and calculating an analyte concentration for the sample by determining an x-axis intercept of the fitted curve.

In accordance to yet another aspect of the disclosure, a method for manufacturing a pre-filled well plate for standard-addition workflows is provided. The method comprises the following steps: receiving a well plate having a first subset of wells and a second subset of wells, wherein the wells in the first subset of wells are intended to receive a portion of a first sample, and the wells in the second subset of wells are intended to receive a portion of a second sample; adding a first-concentration spike to a second well of the first subset of wells, wherein the first-concentration spike has a concentration of a first analyte; adding a second-concentration spike to a third well of the first subset of wells, wherein the second-concentration spike has a higher concentration of the first analyte than the first-concentration spike; adding the first-concentration spike to a second well of the second subset of wells; and adding the second-concentration spike to a third well of the second subset of wells.

In some embodiments, the sampling comprises ejecting one or more droplets from a sample well containing a liquid sample. In some aspects, the ejecting comprises acoustic ejection. In some aspects, the ejection comprises pneumatic ejection.

In some embodiments, the sampling comprises aspirating sample from a sample well containing a liquid sample.

In some embodiments, the sampling comprises directing a laser or electrospray droplets at a sample on a surface.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2 depicts an example view of wells of a well plate.

FIG. 3 depicts example intensities from analyses of samples from four wells of a well plate.

FIG. 4 depicts an example standard addition plot for determining an unknown concentration of an analyte.

FIG. 5 depicts an example method for measuring a concentration of an analyte in a sample.

FIGS. 6A-6B depict another example method for measuring a concentration of an analyte in a sample.

FIG. 7 depicts an example method for manufacturing a pre-filled well plate for standard-addition workflows.

FIG. 8 depicts one example of a suitable operating environment in which one or more of the present examples can be implemented

### DETAILED DESCRIPTION

In some MS applications, experiments and tests are performed to determine the unknown quantity of an analyte in a sample. As just one example, an amount of pesticide (e.g., the analyte) in a food sample is desired to be determined. Due to the complex nature of such a sample and the complexity of the background matrix, directly measuring the amount of the analyte continues to be a challenge. Due to the complex matrix of such samples and the relative difficulty of obtaining a blank matrix, standard addition workflows may be utilized instead of constructing a standard curve. Traditionally, however, such workflows do not resolve the challenge of sample-to-sample matrix variations. For instance, the matrix of one sample may vary from another sample. It has been practically impossible to construct standard addition curves for every sample with traditional MS systems, such as a liquid chromatography (LC) MS based analysis because of the low throughput and necessary sample-cleanup steps used to reduce ion-suppression effects.

As briefly discussed above, high throughput systems introduce the ability to analyze a large number of samples in a short period of time. In one such example, a high analysis throughput using AEMS allows for individual standard addition curves to be generated for every sample without requiring sample cleanup or tuning of the acoustic calibrations. Other types of high analysis throughput systems can also be used where sample liquids (e.g., droplets) from wells in a well plate are sampled. Examples include: aspirating sample using one or more pipettes, pneumatic droplet ejection from sample wells, high-throughput surface sampling, such as liquid atmospheric pressure matrix-assisted laser desorption/ionization (LAP-MALDI), Desorption Electrospray Ionization (DESI), etc. For ease of description, the present application describes high-throughput sampling in the context of one of these methods, AEMS, though it is understood that the principles may apply to other high throughput sampling methods.

In one example, the portions (e.g., aliquots) of a sample may be distributed across a number of wells in a well plate. Each of those wells may then be spiked with a different known amount of the analyte of interest. The liquids in those wells can be sampled and an MS analysis may be performed to determine intensities of the analytes in each of the wells, and a curve/line may be fitted to those intensities to determine an unknown amount of the analyte in the sample. To facilitate such an analysis, well plates may be pre-spiked with analytes to help facilitate the analysis process. The pre-filled well plates may be shipped to labs in a state ready to receive portions of samples without the need to add additional spikes of the analyte.

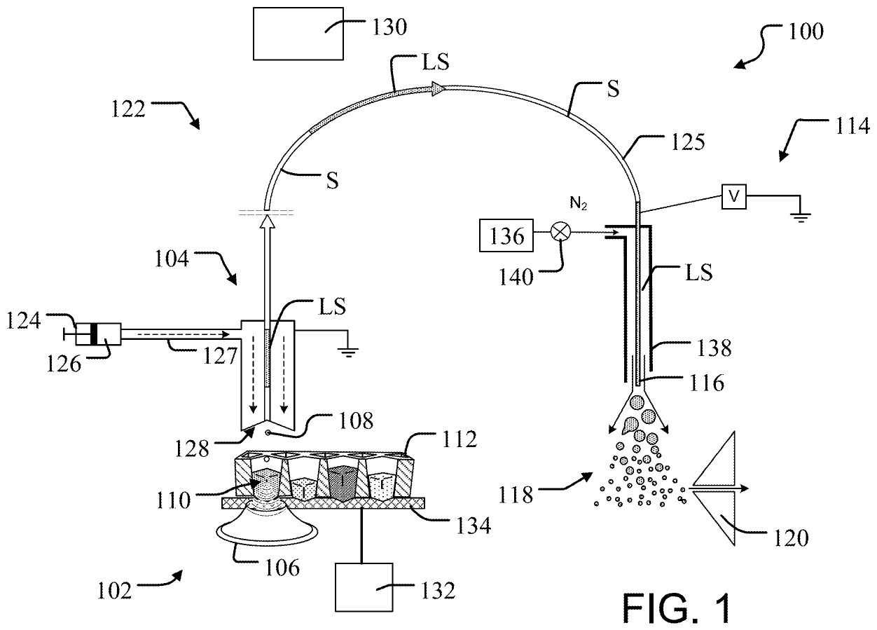

FIG. 1 is a schematic view of an example system 100 combining an ADE 102 with an OPI sampling interface 104 and ESI source 114. The system 100 may be a mass analysis instrument such as a mass spectrometry device that is for ionizing and mass analyzing analytes that receives sampled material within an open end of a sampling OPI. Such a system 100 is described, for example, in U.S. Pat. No. 10,770,277, the disclosure of which is incorporated by reference herein in its entirety. The ADE 102 includes an acoustic ejector 106 that is configured to eject one or more droplets 108 from a well of a well plate 112 into the open end of sampling OPI 104. In other examples, the system 100 may use other types of ejectors, such as a pneumatic ejector. In other types of systems, materials such as droplets may be sampled using other sampling devices such as a needle or an aspirating device (e.g., a syringe). In certain embodiments, the system comprises and ADE 102 and the OPI sampling interface and the sampling is performed by acoustic ejection.

As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are in the gas phase.

A liquid handling system 122 (e.g., including one or more pumps 124 and one or more conduits 125) provides for the flow of liquid from a solvent reservoir 126 to the sampling OPI 104 and from the sampling OPI 104 to the ESI source 114. The solvent reservoir 126 (e.g., containing a liquid, desorption solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPI 104 occurs within a sample space accessible at the open end such that one or more droplets 108 can be introduced into the liquid boundary 128 at the sample tip and subsequently delivered to the ESI source 114.

The system 100 includes an ADE 102 that is configured to generate acoustic energy that is applied to a liquid contained within a reservoir or well 110 that causes one or more droplets 108 to be ejected from the well 110 into the open end of the sampling OPI 104. A controller 130 can be operatively coupled to the ADE 102 and can be configured to operate any aspect of the ADE 102 (e.g., focusing structures, acoustic ejector 106, automation elements 132 for moving a movable stage 134 so as to position a well 110 into alignment with the acoustic ejector 106, etc.). This enables the ADE 102 to inject droplets 108 into the sampling OPI 104 as otherwise discussed herein substantially continuously or for selected portions of an experimental protocol by way of non-limiting example. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1, the ESI source 114 can include a source 136 of pressurized gas (e.g., nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressured gas interacts with the liquid discharged from the electrospray electrode 116 to enhance the formation of the sample plume and the ion release within the plume for sampling by mass analyzer 120, e.g., via the interaction of the high-speed nebulizing flow and jet of liquid sample (e.g., analyte-solvent dilution). The liquid discharged may include discrete volumes of liquid samples LS received from each reservoir 110 of the well plate 112. The discrete volumes of liquid samples LS are typically separated from each other by volumes of the solvent S (hence, as flow of the solvent moves the liquid samples LS from the OPI 104 to the ESI source 114, the solvent may also be referred to herein as a transport liquid). The nebulizer gas can be supplied at a variety of flow rates, for example, in a range from about 0.1 L/min to about 20 L/min, which can also be controlled under the influence of controller 130 (e.g., via opening and/or closing valve 140).

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ESI source 114. By way of non-limiting example, the mass analyzer 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer 120 and is configured to separate ions based on their mobility. Additionally, it will be appreciated that the mass analyzer 120 can comprise a detector that can detect the ions that pass through the mass analyzer 120 and can, for example, supply a signal indicative of the number of ions per second that are detected.

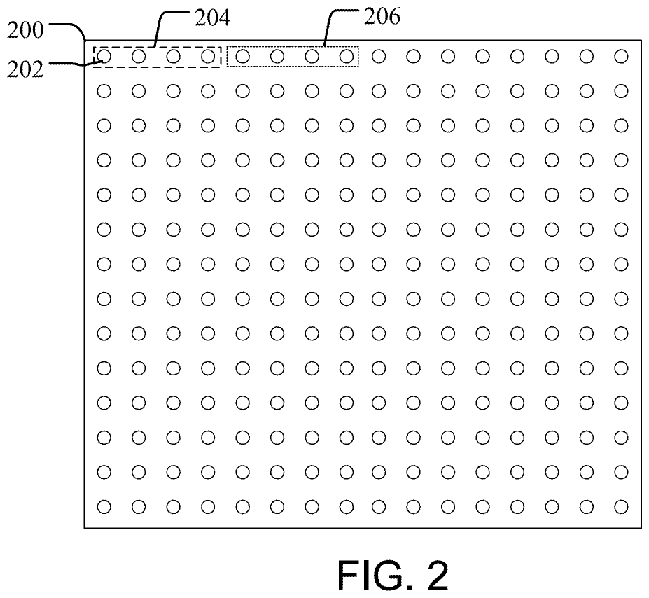

FIG. 2 depicts an example view of wells 202 of a well plate 200. As discussed briefly above, aliquots or portions of a sample may be divided into a subset of wells 202 of a well plate 200. For example, portions of a first sample may be divided among a first subset 204 of four wells 202, and portions of a second sample may be divided among a second subset 206 of four wells 202. While four wells 202 are used as an example number of wells 202, any number of wells could be used, such a 3, 4, 5, 6, 7, 8, 9, or 10 wells. In some examples, between 5-10 wells 202 may utilized. In other examples, at least 4 wells 202 may be utilized.

The same volume of aliquot may be added to each of the wells 202 in the respective subset 204 or subset 206. For example, each well 202 in the first subset 204 may receive the same volume of an aliquot or portion of the sample to be analyzed. As some examples, for a 1536-well plate, the volumes of aliquots may range from 1.5 microliters (μL) to 5 μL, and for a 384-well plate, the volumes of aliquots may range from 5-50 μL.

To facilitate the standard addition workflow, different known concentrations of the analyte of interest are added to at least some of the wells 202 of the respective subsets 204, 206. The added concentration of the analyte may be referred to herein as a “spike.” Each added spike may have a different concentration. One of the wells in each sample, however, may not be spiked or receive a solution with no additional analyte (e.g., a zero-concentration spike). In the example depicted where the first subset 204 includes four wells 202, no spike or a zero-concentration spike is added to the first well, a first-concentration spike is added to the second well, a second-concentration spike is added to the third well, and a third-concentration spike is added to the fourth well. The first-concentration spike has a first known concentration of the analyte, the second-concentration spike has a second known concentration of the analyte, and third-concentration analyte has a third known concentration of the analyte. The second concentration may be greater than the first concentration, and the third concentration may be greater than the second concentration.

Despite having different concentrations, the volume of the spikes may be the same such that the total volume (e.g., aliquot and spike) remains the same in each of the wells. Similarly, by adding spikes with the same volume and matrix composition, the volume ratio between the raw sample and the spike also remains the same across the wells of the subsets. By maintaining the same volume in each of the wells, the droplet(s) ejected from each of the wells are more likely to be of a consistent size and composition. In some examples, the amount liquid ejected from the well is on the order of a few nanoliters, either as one or more droplets.

Similar spikes may be added to the wells of the second subset 206 of wells. As should be appreciated, the spikes may be added for subsets having fewer or greater than four wells per subset. Further, the spikes may be added to all subsets of the well plate such that the entire well plate may be used for analysis.

As a specific non-limiting example, the sample may be a food sample, such as lettuce, and the analyte of interest may be a pesticide. The lettuce (or a portion thereof) may be divided across the four wells of the first subset in equal volumes. Spikes of the pesticide may then be added to the wells of the subset. For example, the first-concentration spike may a be a spike having a concentration of 5 parts-per-billion (ppb) of the pesticide, the second-concentration spike may be a spike having a concentration of 15 ppb of the pesticide, and the third-concentration spike may be a spike having a concentration of 80 ppb of the pesticide.

Once the wells have been prepared by adding the aliquots and the spikes, the samples may be analyzed by a mass spectrometry system that includes a sampling system, such as a system that includes an ejection system such as an acoustic ejection system or a pneumatic ejection system. For instance, droplets from each of the wells may be ejected and then analyzed by the mass spectrometry system to generate an intensity of the analyte in each of the wells.

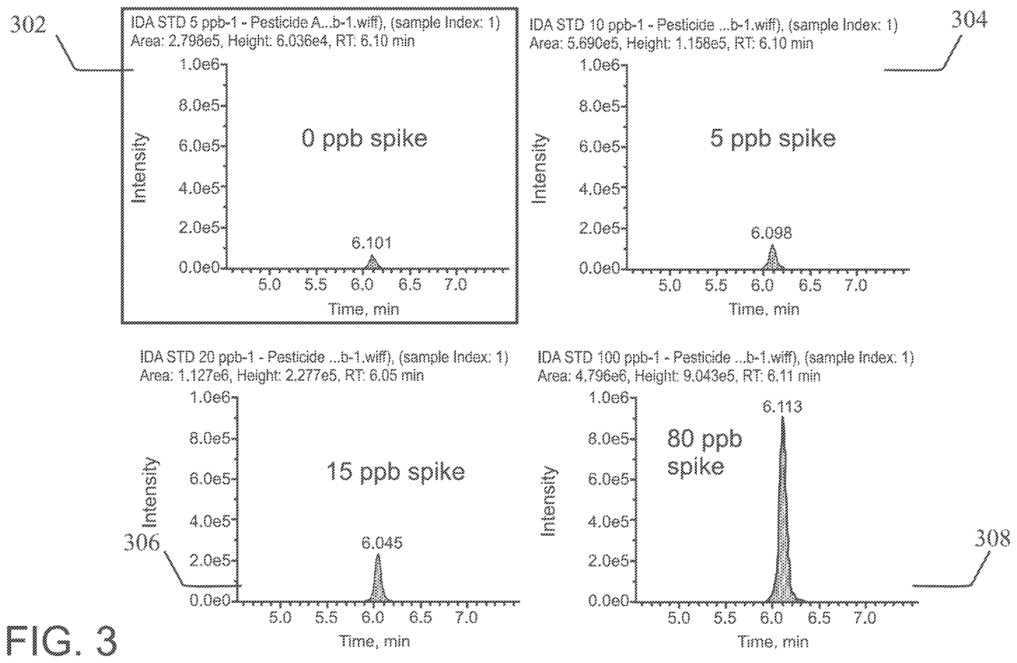

FIG. 3 depicts example intensities from an analysis of samples from four wells of a well plate. More specifically, FIG. 3 includes a first intensity plot 302, a second intensity plot 304, a third intensity plot 306, and a fourth intensity plot 308. Each intensity plot corresponds to the mass spectrometry results for a different well of a well plate. For example, the first intensity plot 302 corresponds to a first well of a subset of wells that had no spike or a zero-concentration spike added. The second intensity plot 304 corresponds to a second well of a subset of wells that had a first-concentration spike added. The third intensity plot 306 corresponds to a third well of a subset of wells that had a second-concentration spike added. The fourth intensity plot 308 corresponds to a fourth well of the subset of wells that had a third-concentration spike added. The intensity plots are representative of counts of ions corresponding to the analyte that were detected over a period of time (e.g., such as through MRM analysis).

The intensity for each plot/well may be determined based on characteristics of the peaks in the plots. For instance, the intensity may be equal to the area under the peak and/or the maximum height of the peak. In the present example, the intensity is calculated as the area under the peak.

The intensity plots in FIG. 3 continue with the food sample (e.g., lettuce) and pesticide example discussed above. More specifically, in the example depicted, the first-concentration spike may be a spike having a concentration of 5 parts-per-billion (ppb) of the pesticide, the second-concentration spike may be a spike having a concentration of 15 ppb of the pesticide, and the third-concentration spike may be a spike having a concentration of 80 ppb of the pesticide.

The determined intensity for the peak in the first intensity plot 302 is 2.798e5. The determined intensity for the peak in the second intensity plot 304 is 5.690e5. The determined intensity for the peak in the second intensity plot 306 is 1.127e6. The determined intensity for the peak in the third intensity plot 308 is 4.796e6. To determine the unknown amount of the analyte (e.g., the pesticide) in the sample, the determined intensities may be plotted against the added concentration values for the wells, as discussed further below.

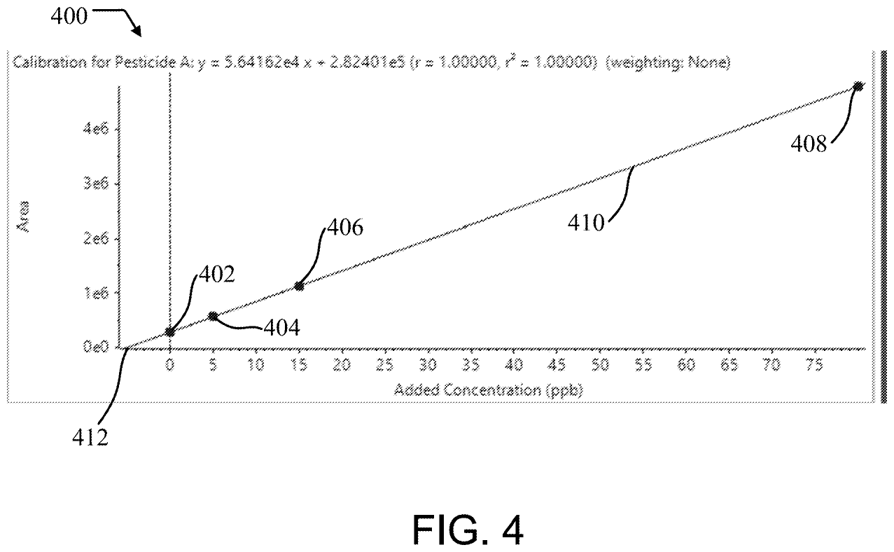

FIG. 4 depicts an example standard addition plot 400 for determining an unknown concentration of an analyte in the analyzed sample. The intensity plot has a y-axis representing measured intensity (e.g., area of the peaks discussed above), and an x-axis of added concentration. The intensities determined for each the intensity plots in FIG. 3 are plotted against the corresponding added concentration amount. For instance, point 402 corresponds to the first well with the raw sample with no added analyte concentration (e.g., added concentration of zero), which had a measured intensity of 2.798e5. Point 404 corresponds to the second well with the sample and the first-concentration spike of 5 ppb, which had a measured intensity of 5.690e5. Point 406 corresponds to the third well with the sample and the second-concentration spike of 15 ppb, which had a measured intensity of 1.127e6. Point 408 corresponds to the fourth well with the sample and the third-concentration spike of 80 ppb, which had a measured intensity of 4.796e6.

A curve or line 410 may be fit to the data points 402-408 plotted in the plot 400. The curve or line may be fit using any type of suitable line-fitting algorithms, such as linear regression. The point 412 at which the curve or line intersects the x-axis (e.g., y=0), indicates the concentration of the analyte in the raw sample. In the example predicted, the x-axis intercept is equal to −5.01 ppb, which indicates that the concentration of the analyte in the raw sample is 5.01 ppb.

While the above plot is for a standard addition curve using area measurements of an analyte, additionally or alternatively, an internal standard may be used in combination with an analyte to generate a standard curve and be utilized to determine the concentration of the analyte in the raw sample. In such examples, the internal standard curve may be for a plot having an x-axis of spiked concentration and a y-axis of the intensity ratio of the target analyte over internal standard. In one implementation, the internal standard concentration is a constant value throughout all samples. An internal standard is different from the spiked standard. The internal standard typically an isotope labelled version of the compound. The same amount is added to all samples and is used to correct for things like autosampler injection variability, ion suppression, and losses during sample preparation.

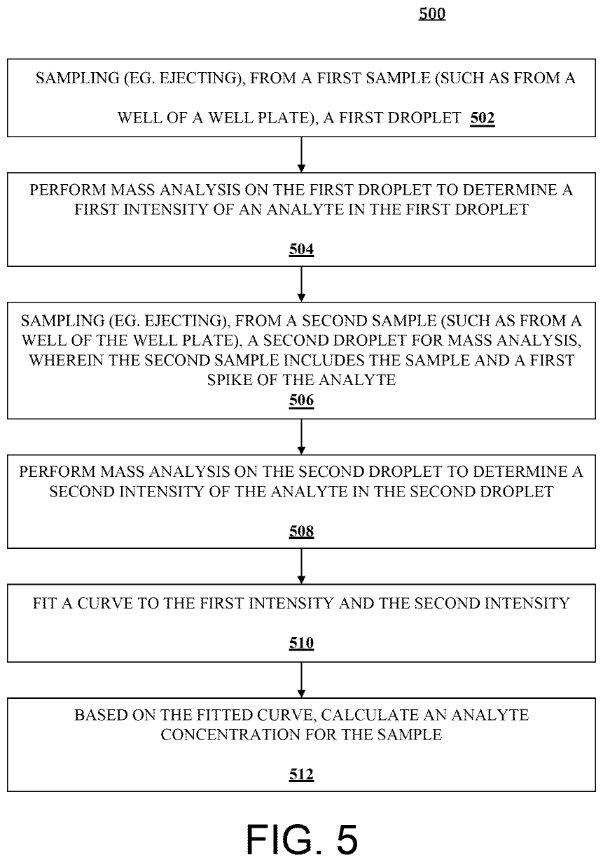

FIG. 5 depicts an example method 500 for identifying a concentration of an analyte in a sample. At operation 502, a first droplet is sampled (e.g., ejected) from a first sample such as a sample contained in a well of the well plate. The first droplet is sampled into a mass analysis system. While the term droplet is used, one or more droplets may be sampled and the use of one droplet should be understood to include one or more droplets that result from a single sampling event. The droplet(s) may be on a nanoliter scale (e.g., the amount ejected may measure a few nanoliters). The first droplet may be sampled by ejection which can be for example ejecting acoustically or pneumatically. The first sample or when a well is used in the first well of the well plate includes a portion of a sample to be analyzed to determine an unknown amount of an analyte. The first sample may also include a zero-concentration spike of the analyte. Again, it should be noted that each sampling event could be either a single-droplet sampling event or a multi-droplet sampling event from the same well when wells are used.

At operation 504, mass analysis is performed on the ejected first droplet to determine a first intensity of the analyte in the first droplet. The first intensity may be calculated as a height of the resultant ion count peak and/or the area of the peak, as discussed above. The mass analysis may be performed via a variety of mass analysis methods, including multiple reaction monitoring (“MRM”), selective reaction monitoring (“SRM”), time-of-flight (“TOF”), etc.

At operation 506, a second droplet is sampled (e,g., ejected) from a second sample such as from a second well of the well plate. The time between the sampling of first droplet and the second droplet may be relatively small to allow for and capture the increased throughput of the system. For instance, the second droplet may be sampled within less than 5 seconds, less than 2 seconds, or less than one second from the sampling of the first droplet. Such a rapid sampling and analysis allows for an entire workflow to be completed within a minute, even where 10 wells are used in the analyzed subset of wells (e.g., 10-concentration points). Triplicate analyses may even be used and still complete the analyses within roughly a minute. In preferred embodiments, the sampling is performed by ejection from a well in a well plate.

The second sample such as that from a second well of the well plate includes a portion of the sample and a first spike of the analyte. The first spike of the analyte has a known analyte concentration. The second droplet may be sampled in a similar manner as the first droplet. At operation 508, mass analysis is performed on the second droplet to determine a second intensity of the analyte in the second droplet. The intensity of the analyte in the second droplet is determined or calculated in the same manner as the intensity for the first droplet.

At operation 510, a curve/line is fit to the first intensity determined at operation 504 and the second intensity determined at operation 508. The first intensity and the second intensity may be represented as data points with an intensity-based value and a concentration-based value. For instance, each data point may be represented as a pair such as: {intensity, concentration}. In standard addition, the intensity-based value is the measured intensity, and the concentration-based value is the known added concentration. With an internal standard, the intensity-based value is an intensity ratio (intensity of the analyte/intensity of the internal standard), and the concentration ratio is a concentration ratio (known concentration of the analyte/known concentration of the internal standard).

The curve may be fit through the data points using any known curve fitting algorithms, such as linear regression. As an example, the first intensity and the second intensity may be plotted on a plot having an x-axis based on concentration of the analyte and a y-axis based on the measured intensity. A regression may then be performed to fit the curve.

At operation 512, an analyte concentration for the sample is calculated or determined based on the fitted curve. As an example, an x-axis intercept of the curve (e.g., where the intensity value of the curve equals zero) may be determined, and that intercept (or the negative of that intercept) may be used as the concentration of the analyte in the sample. While only two wells are discussed as being used in method 500, additional wells of a subset of wells may be analyzed as discussed above.

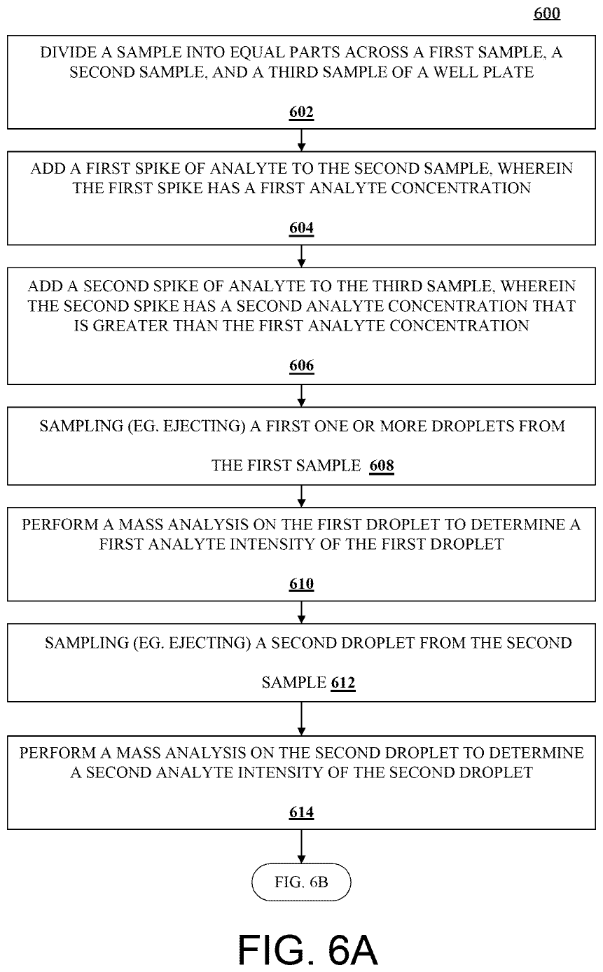

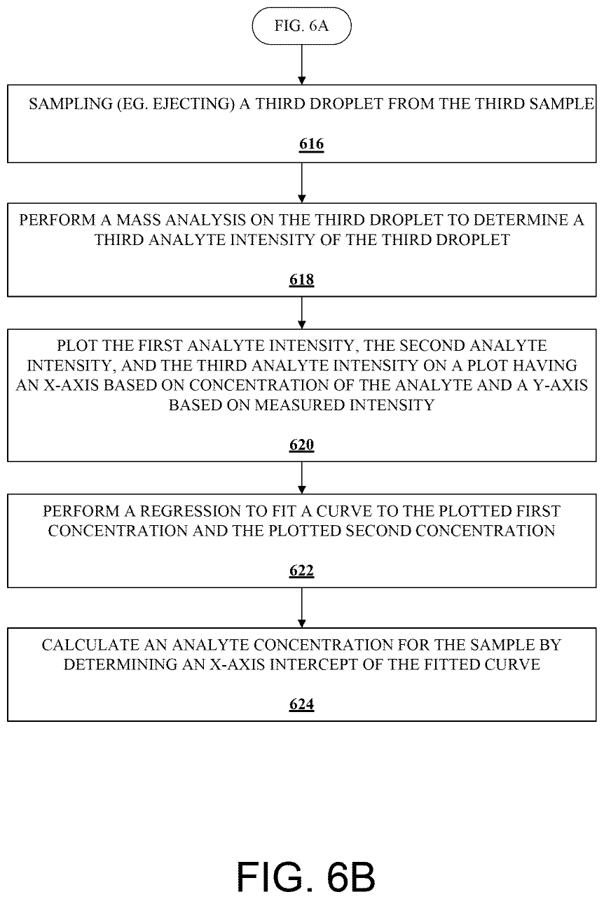

FIGS. 6A-6B depict another example method 600 for identifying a concentration of an analyte in a sample. At operation 602, a sample is divided into equal parts across a subset of wells of a well plate. For example, the sample may be divided across a first sample such as contained in a first well, a second sample such as contained in a second well, and a third sample such as contained in a third well of a well plate. The sample includes an unknown amount of an analyte of interest. The method 600 may be used to determine the concentration and/or amount of the analyte of interest in the sample.

At operation 604, a first spike of the analyte is added to the second sample such as contained in a second well. The first spike has a first analyte concentration. In some examples, a zero-concentration spike may also be added to the first sample such as contained in a first well. At operation 606, a second spike of the analyte is added to the third sample such as contained in a third well. The second spike has a second analyte concentration that is greater than the first analyte concentration.

At operation 608, a first droplet is sampled from the first sample. At operation 610, a mass analysis is performed on the first droplet to determine the first analyte intensity of the first droplet. At operation 612, a second droplet is sampled from the second sample. At operation 614, a mass analysis is performed on the second droplet to determine a second analyte intensity of the second droplet. At operation 616, a third droplet is sampled from a third sample. At operation 618, a mass analysis is performed on the third droplet to determine a third analyte intensity of the third droplet. The droplets may be sampled and analyzed in any of the manners discussed above. Similarly, the intensities may be calculated or determined in any of the manners discussed above. The first, second and third samples may be contained within first, second and third wells, respectively, in a well plate, for example.

At operation 620, the first analyte intensity, the second analyte intensity, and the third analyte intensity are plotted on a plot having an x-axis based on concentration and a y-axis based on measured intensity. At operation 622, a regression is performed to fit a curve to the first analyte intensity, the second analyte intensity, and the third analyte intensity. At operation 624, an analyte concentration for the sample is calculating by determining an x-axis intercept of the fitted curve.

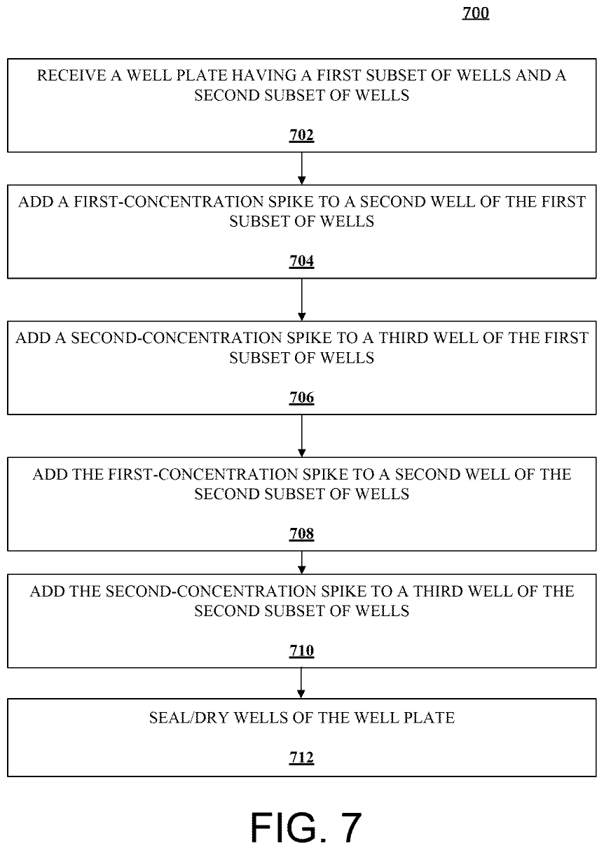

FIG. 7 depicts an example method 700 for manufacturing a pre-filled well plate for standard-addition workflows. As discussed above, portions of a sample and the spikes may be added to the well plates for mass analysis. These sample/spike preparations may occur just prior to analysis or within some relatively short period prior to the mass analysis. In other examples, the well plates may be manufactured or pre-prepared with the spikes prior to receiving the samples or even prior to the laboratories. Thus, when the plate is received by the laboratory or technician, all that needs to be added is the samples. The subsets of wells may be also indicated on the well plates. For instance, an outline or other indicator for each subset of wells (e.g., the first subset and the second subset of wells depicted in FIG. 2) may be printed on the well plate. The concentration and/or type of analyte added into the wells of the subsets may also be indicated directly on the well plate.

At operation 702, a well plate is received. The well plate includes a first subset of wells and a second subset of wells. At operation 704, a first-concentration spike is added to a second well of the first subset of wells. The first-concentration spike includes a first concentration of a first analyte. In some examples, a zero-concentration spike may be added the first well of the first subset of wells. In other examples, the first well may be left blank or empty. At operation 706, a second-concentration spike is added to a third well of the first subset of wells. The second-concentration spike has a higher concentration of the first analyte than the first-concentration spike. In some examples, the spikes (e.g., first-concentration spike, second concentration spike, etc.) may also include buffers or reagents to help stabilize the spikes. The buffers and/or reagents may vary based on the type of analyte and from assay to assay depending on the samples intended to be tested.

At operation 708, the first-concentration spike is added to a second well of the second subset of wells. Similar to the first subset of wells, a zero-concentration spike may also be added to a first well of the second subset of wells. At operation 710, the second-concentration spike is added to a third well of the second subset of wells.

As should be appreciated, additional subsets of wells in the well plate may also be similarly prepared. In addition, the well plate may also be prepared with different types of analytes as well such that the plate may be used for the analysis of multiple types of analytes. For example, a first-concentration spike of a second analyte may be added to a second well of a third subset of wells on the well plate, and a second-concentration spike of the second analyte may be added to a third well of the third subset of wells.

At operation 712, the well plate is sealed and/or dried to allow for the well plate to transported after the spikes have been added to the well plate. Additional packaging of the well plate may also be performed to allow for shipment and/or transport of the prepared well plate.

The present technology provides substantial benefits for increasing the ability to measure unknown analytes in samples. In addition, because of the small sample loading amount (nanoliter size) and the high dilution factor (several hundred folds), no sample cleanup may be required. Further, a direct analysis of straight plasma may be achieved with observing significant ion suppression or matrix effects normally associated with such analysis. Due to the sample-loading process, calibration settings of the acoustic ejector (e.g., acoustic power, duration, frequency, etc.) may not need to be readjusted for different samples.

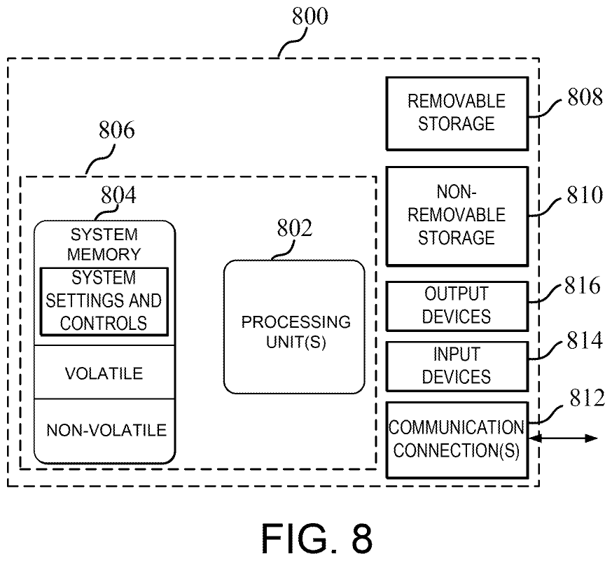

FIG. 8 depicts one example of a suitable operating environment 800 in which one or more of the present examples can be implemented. This operating environment may be incorporated directly into the controller for a mass spectrometry system, e.g., such as the controller depicted in FIG. 1, and/or additional processing components that may be used to analyze the mass analysis data. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 800 typically includes at least one processing unit 802 and memory 804. Depending on the exact configuration and type of computing device, memory 804 (storing, among other things, instructions to control the eject the samples, move the stage, or perform other methods disclosed herein) can be volatile (such as RAM), non-volatile (such as ROM, flash memory, etc.), or some combination of the two. This most basic configuration is illustrated in FIG. 8 by dashed line 806. Further, environment 800 can also include storage devices (removable 808, and/or non-removable 810) including, but not limited to, magnetic or optical disks or tape. Similarly, environment 800 can also have input device(s) 814 such as touch screens, keyboard, mouse, pen, voice input, etc., and/or output device(s) 816 such as a display, speakers, printer, etc. Also included in the environment can be one or more communication connections 812, such as LAN, WAN, point to point, Bluetooth, RF, etc.

Operating environment 800 typically includes at least some form of computer readable media. Computer readable media can be any available media that can be accessed by processing unit 802 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 800 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 800 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 800 is part of a network that stores data in remote storage media for use by the computer system 800.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method for measuring a concentration of an analyte in a sample, the method comprising:
sampling a first one or more droplets for mass analysis, wherein the first one or more droplets include the sample;
performing mass analysis on the first one or more droplets to determine a first intensity of an analyte in the first one or more droplets;
sampling a second one or more droplets for mass analysis, wherein the second one or more droplets include the sample and a first spike of the analyte;
performing mass analysis on the second one or more droplets to determine a second intensity of the analyte in the second one or more droplets;
fitting a curve to the first intensity and the second intensity; and
based on the fitted curve, calculating an analyte concentration for the sample.

2. The method of claim 1, wherein the curve is a line.

3. The method of claim 1, wherein fitting the curve comprises:
plotting the first intensity and the second intensity on a plot having an x-axis based on concentration of the analyte and a y-axis based on measured intensity; and
performing a regression to fit the curve to the plotted first intensity and the plotted second intensity.

4. The method of claim 3, wherein calculating the analyte concentration for the sample incudes determining an x-axis intercept of the fitted curve.

5. The method of claim 3, wherein the x-axis represents added concentration and the y-axis represents the measured intensity.

6. The method of claim 1, further comprising:
sampling a third one or more droplets for mass analysis, wherein the third one or more droplets include the sample and a second spike of the analyte, wherein the second spike has a higher concentration of analyte than a concentration of the first spike;
performing mass analysis on the third one or more droplets to determine a third intensity of the analyte in the third one or more droplets; and
wherein the curve is further fitted to the third intensity.

7. The method of claim 6, wherein the sampling comprises ejecting the droplets from separate sample wells that each have the same volume of combined liquid.

8. The method of claim 1, wherein the first one or more droplets include a zero-concentration spike.

9. The method of claim 1, wherein the sampling of the second one or more droplets occurs within 2 seconds after sampling of the first one or more droplets.

10. The method of claim 6, wherein the sampling of the first one or more droplets and the second one or more droplets and the third one or more droplets is performed by ejecting droplets from liquid samples.

11. (canceled)

12. A method for measuring a concentration of an analyte in a sample, the method comprising:
dividing a sample into three equal parts to produce a first sample, a second sample, and a third sample;
adding a first spike of the analyte to the second sample, wherein the first spike has a first analyte concentration;
adding a second spike of the analyte to the third sample, wherein the second spike has a second analyte concentration that is greater than the first analyte concentration;
sampling a first one or more droplets from the first sample;
performing a mass analysis on the first one or more droplets to determine a first analyte intensity of the first one or more droplets;
sampling a second one or more droplets from the second sample;
performing a mass analysis on the second one or more droplets to determine a second analyte intensity of the second one or more droplets;
sampling a third one or more droplets from the third sample;
performing a mass analysis on the third one or more droplets to determine a third analyte intensity of the third one or more droplets;
plotting the first analyte intensity, the second analyte intensity, and the third analyte intensity on a plot having an x-axis of based on concentration of the analyte and a y-axis based on measured intensity;
performing a regression to fit a curve to the plotted first analyte intensity, the second analyte intensity, and the third analyte intensity; and
calculating an analyte concentration for the sample by determining an x-axis intercept of the fitted curve.

13. The method of claim 12, wherein the sampling of the first one or more droplets, the second one or more droplets, and the third one or more droplets is performed by acoustic ejection.

14. The method of claim 12, wherein the curve is a line.

15. The method of claim 12, wherein the x-axis represents added concentration and the y-axis represents the measured intensity.

16. The method of claim 12, wherein the first spike and the second spike have the same volume.

17. The method of claim 16, further comprising adding a zero-concentration spike to the first sample such that the first sample, second sample, and third sample include the same volume of liquid.

18. A method for manufacturing a pre-filled well plate for standard-addition workflows, the method comprising:
receiving a well plate having a first subset of wells and a second subset of wells, wherein the wells in the first subset of wells are intended to receive a portion of a first sample, and the wells in the second subset of wells are intended to receive a portion of a second sample;
adding a first-concentration spike to a second well of the first subset of wells, wherein the first-concentration spike has a concentration of a first analyte;
adding a second-concentration spike to a third well of the first subset of wells, wherein the second-concentration spike has a higher concentration of the first analyte than the first-concentration spike;
adding the first-concentration spike to a second well of the second subset of wells; and
adding the second-concentration spike to a third well of the second subset of wells.

19. The method of claim 18, further comprising:
adding a zero-concentration spike to a first well of the first subset of wells; and
adding the zero-concentration spike to a first well of the second subset of wells.

20. The method of claim 18, wherein the well plate includes a third subset of wells intended to receive a portion of a third sample, and the method further comprises:
adding a first-concentration spike of a second analyte to a second well of the third subset of wells; and
adding a second-concentration spike of the second analyte to a third well of the third subset of wells, wherein the second-concentration spike of the second analyte has a higher concentration of the second analyte than the first-concentration spike of the second analyte.

21. The method of claim 18, further comprising performing at least one of drying or sealing the wells of the well plate for transport.
